(19) United States
(12) Patent Application Publication
(10) Pub. No.: US 2015/0276994 A1
(43) Pub. Date: Oct. 1, 2015

(54) METHOD OF MAKING A LENS ARRAY PLATE WITH AN APERTURE MASK LAYER

(71) Applicant: Forward Optics Co., LTD., Taichung City (TW)

(72) Inventors: Wei Shen, Taichung City (TW); Yuan-Lin Lee, Taichung City (TW)

(73) Assignee: Forward Optics Co., LTD., Taichung City (TW)

(21) Appl. No.: 14/229,277

(22) Filed: Mar. 28, 2014

(51) Int. Cl. G02B 3/00

(52) U.S. Cl. CPC G02B 3/0012

(57) ABSTRACT

A method of making a lens array plate with an aperture mask layer includes: preparing a lens substrate which is made from a plastic material and which has a plurality of spaced apart clear aperture regions for passage of light therethrough, and a mask-forming region which surrounds the clear aperture regions; and carbonizing the plastic material at the mask-forming region so as to form a carbonized aperture mask layer at the mask-forming region that can block ambient light from passing therethrough.

### BACKGROUND OF THE INVENTION

1. Field of the Invention

This invention relates to a method of making a lens array plate, more particularly to a method of making a lens array plate with an aperture mask layer that is formed using laser techniques.

2. Description of the Related Art

U.S. Patent Application Publication No. 2005/0264895 discloses a method of making a lens. The method includes disposing a mask aperture layer in a mold, followed by using injection molding techniques to form a lens array plate connected to the mask aperture layer. The mask aperture layer has a melting point different from that of the lens array plate, which complicates the method and results in a decrease in the yield of the lens. U.S. Patent Application Publication No. 2013/0250404 discloses another method of making a lens. The method includes plating a non-patterned mask aperture layer on a surface of a lens array plate, followed by removing a portion of the non-patterned mask aperture layer using photolithography techniques with a mask so as to form a patterned mask aperture layer. However, a very high precision is required for aligning the mask with the lens array plate. In addition, a resist stripper and a developer used in the photolithography technique of the non-patterned mask aperture layer tend to damage clear aperture regions of the lens array plate.

### SUMMARY OF THE INVENTION

Therefore, an object of the present invention is to provide a method of making a lens array plate with an aperture mask layer that can overcome the aforesaid drawbacks associated with the prior art.

According to this invention, there is provided a method of making a lens array plate with an aperture mask layer. The method comprises: preparing a lens substrate which is made from a plastic material and which has a plurality of spaced apart clear aperture regions for passage of light therethrough, and a mask-forming region which surrounds the clear aperture regions; and carbonizing the plastic material at the mask-forming region so as to form a carbonized aperture mask layer at the mask-forming region that can block ambient light from passing therethrough.

### BRIEF DESCRIPTION OF THE DRAWINGS

In drawings which illustrate an embodiment of the invention,

FIG. 1 is a perspective view of the preferred embodiment of a method of making a lens array plate according to the present invention, which illustrates how an aperture mask layer of the lens array plate is formed using a laser beam;

FIG. 2 is a perspective view of the preferred embodiment of a lens array plate according to the present invention; and

FIG. 3 is a sectional view of the preferred embodiment of the lens array plate.

### DETAILED DESCRIPTION OF THE PREFERRED EMBODIMENT

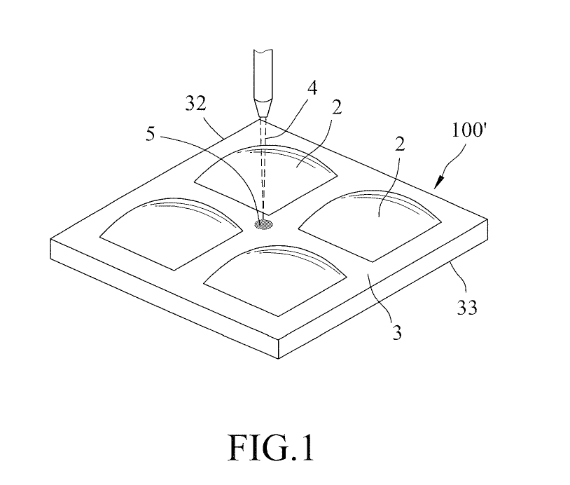

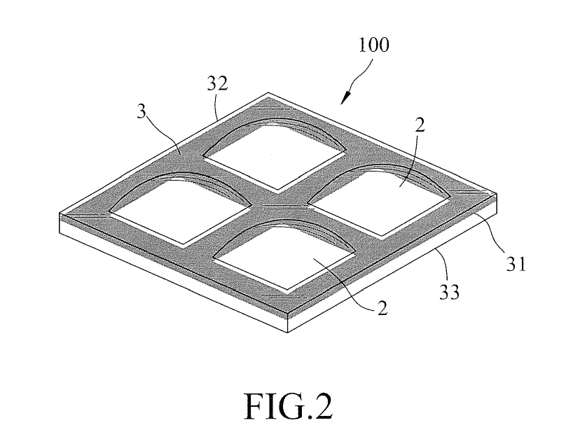

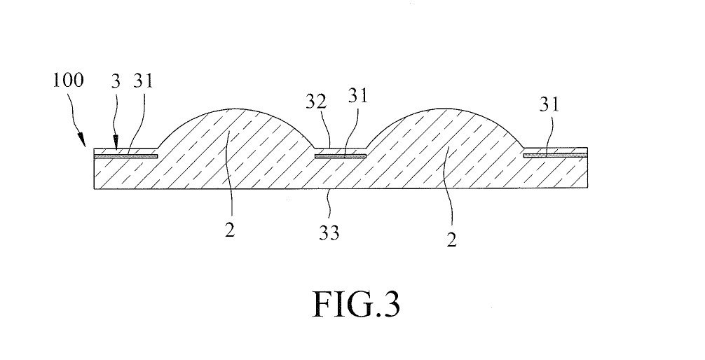

FIG. 1 illustrates how an aperture mask layer of a lens array plate is formed by a method according the preferred embodiment of the present invention. FIG. 2 and FIG. 3 illustrate the preferred embodiment of the lens array plate with the aperture mask layer according to the present invention.

The lens array plate 100 is made from a lens substrate 100′ of a plastic material, and has a plurality of spaced apart clear aperture regions 2, a mask forming region 3 that surrounds the clear aperture regions 2, and a carbonized aperture mask layer 31 that is formed at the mask forming region 3. In the preferred embodiment, the lens array plate 100 is made from the lens substrate 100′ of an optical plastic material. Examples of the optical plastic material include PMMA (polymethyl methacrylate, available from MITSUBISHI RAYON CO., LTD.), PC-AD5503 (Polycarbonate, available from TEIJIN LIMITED), ZEONEX® 480R (available from Zeon Chemicals LP), and ULTEM-1010 (available from Saudi Basic Industries Corporation Innovative Plastics).

The clear aperture regions 2 are optically active areas for passage of light therethrough. Each of the clear aperture regions 2 may be a spherical lens, an aspheric lens, a freeform lens, a flat lens, or any other type of lens.

In the preferred embodiment, the carbonized aperture mask layer 31 is formed between and is spaced apart from a top surface 32 of the mask-forming region 3 and a bottom surface 33 of the mask-forming region 3. Alternatively, the carbonized aperture mask layer 31 may be formed at the top surface 32 of the mask-forming region 3 or the bottom surface 33 of the mask-forming region 3.

FIG. 1 illustrates how the carbonized aperture mask layer 31 of the lens array plate 100 is formed by a method according to the present invention. The method includes the steps of: preparing a lens substrate 100′ which is made from a plastic material and which has a plurality of the spaced apart clear aperture regions 2 for passage of light therethrough, and a mask-forming region 3 which surrounds the clear aperture regions 2; and irradiating the mask-forming region 3 with a laser beam 4 to carbonize the plastic material at the mask-forming region 3 so as to form the opaque carbonized aperture mask layer 31 at the mask-forming region 3 that can block ambient light from passing therethrough.

The laser beam 4 is focused onto the lens substrate 100′, such that the carbonized aperture mask layer 31 thus formed is formed between and is spaced apart from the top surface 32 of the mask-forming region 3 and the bottom surface 33 of the mask-forming region 3.

In the preferred embodiment, the laser beam 4 has a focal point 5 with a radius of about 0.06 mm. The laser beam 4 has an output power ranging from 5 W to 30 W. Preferably, the laser beam 4 has an output power of 30 W. The laser beam 4 is a continuous-wave laser. The quality of the carbonized aperture mask layer 31 is controlled by the radius of the focal point 5 of the laser beam 4, a depth of focus of the laser beam 4, and the output power of the laser beam 4.

By carbonizing the plastic material at the mask-forming region 3 using a laser beam 4 in the method of the present invention, a well-defined opaque aperture mask layer 31 in or on the lens array plate 100 may be easily obtained, thereby alleviating the aforesaid drawbacks associated with the prior art. The carbonized aperture mask layer 31 formed by the method of the present invention has a stable structure, and is resistant to harsh environmental effects. In addition, by using the laser beam 4 having an output energy of 30 W and a radius of about 0.06 mm in the method of the present invention, the lens array plate 100 with the clear aperture regions 2 having a relatively small size can be easily and precisely formed. Moreover, the use of the laser beam 4 in the method of the present invention facilitates alignment of the mask-forming region 3 and permits the method of this invention to be particularly suitable for forming the carbonized aperture mask layer 31 with a uniform thickness on a planar surface or a non-planar surface.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A method of making a lens array plate with an aperture mask layer, the method comprising:
preparing a lens substrate which is made from a plastic material and which has a plurality of spaced apart clear aperture regions for passage of light therethrough, and a mask-forming region which surrounds the clear aperture regions; and
carbonizing the plastic material at the mask-forming region so as to form a carbonized aperture mask layer at the mask-forming region that can block ambient light from passing therethrough.

2. The method of claim 1, wherein the carbonizing of the plastic material is conducted using a laser beam.

3. The method of claim 2, wherein the laser beam is focused on the mask-forming region such that the carbonized aperture mask layer is formed between and is spaced apart from a top surface of the mask-forming region and a bottom surface of the mask-forming region.

4. The method of claim 2, wherein the laser beam has a focal point with a radius of about 0.06 mm.

5. The method of claim 2, wherein the laser beam is a continuous-wave laser.

6. The method of claim 5, wherein the laser beam has an output energy ranging from 5 W to 30 W.
